(19) United States
(12) Patent Application Publication
(10) Pub. No.: US 2026/0267980 A1
(43) Pub. Date: Sep. 10, 2026

(54) Secure Hardware Root of Trust Using Trusted Execution Environment and Physical Unclonable Function

(71) Applicant: FURONG BEI, SAN GABRIEL, CA (US)

(72) Inventor: FURONG BEI, SAN GABRIEL, CA (US)

(21) Appl. No.: 19/181,772

(22) Filed: Apr. 17, 2025

(51) Int. Cl. G06F 21/57; G06F 21/64; H04L 9/32

(52) U.S. Cl. CPC G06F 21/572; G06F 21/64; H04L 9/3218; H04L 9/3247; H04L 9/3278

(57) ABSTRACT

A secure hardware root-of-trust system for domain-associated credential protocols is provided. A PUF module or equivalent hardware-unique signal source generates or recovers a stable device-unique identity value from which a hardware-rooted cryptographic key is derived or released. A TEE, secure enclave, secure element, or equivalent isolated execution environment verifies measured firmware, protocol code, credential-generation code, or execution state before using the key. A behavior-signature engine generates a behavior-time proof, and credential-generation circuitry cryptographically binds the proof, the key, and an integrity measurement into a behavioral credential associated with a domain, service endpoint, verifier context, terminal context, or defined verification scope. Signed attestation evidence including verifier freshness information is transmitted to a remote verifier over a secure channel. The improvement concerns chip-level trust functionality and credential-generation security without changing semiconductor fabrication, lithography, packaging, or transistor manufacturing processes.

### CROSS-REFERENCE TO RELATED APPLICATIONS

Any domestic benefit, priority, continuation, continuation-in-part, divisional, or related-application relationship intended to be relied upon is claimed only to the extent properly set forth in an Application Data Sheet or other accepted USPTO filing record. This substitute specification for application Ser. No. 19/181,772 does not by itself add or alter any domestic benefit claim.

### TITLE AND TECHNICAL FIELD

The disclosed technology relates to a secure hardware root of trust using a Trusted Execution Environment (TEE), a Physical Unclonable Function (PUF), or an equivalent hardware-rooted trust structure for hardware-rooted behavioral credential attestation, measured integrity gating, behavior-time proof generation, domain-associated credential binding, and remote attestation.

The technology may combine a hardware-unique signal source, an isolated execution environment, a measured integrity gate, a key derivation or key release function, a behavior signature engine, a credential generation module, an attestation interface, and a secure communication channel. Representative implementations include a PUF, TEE, secure element, secure enclave, trusted module, isolated secure processor, or equivalent hardware-rooted trust structure.

The disclosed technology may be implemented in, or coupled to, a chip, secure element, trusted execution module, secure enclave, device processor, or hardware trust module. The improvement is directed to chip-level trust functionality and credential-generation security, and does not require a change to semiconductor wafer fabrication, lithography, packaging, or transistor manufacturing processes.

The invention is not limited to a single commercial identity platform. It may operate as a hardware trust foundation for terminals, institutional systems, financial systems, medical systems, public-service systems, industrial devices, domain-linked services, and other infrastructures that require device-authentic, code-integrity-gated, behavior-bound verification.

### BACKGROUND

Software-only key storage may be vulnerable to malware, memory scraping, device cloning, credential theft, replay attacks, and unauthorized use of a valid credential from an untrusted execution state. A credential that is valid as a static data object does not necessarily prove that the issuing device was physically authentic, that firmware was unmodified, or that a behavior-time event actually satisfied a verifier policy.

Trusted Execution Environments can isolate execution and protect keys, but a TEE alone does not necessarily provide a unique physical identity for each device. A Physical Unclonable Function can provide a device-specific physical response, but a PUF alone does not necessarily verify that firmware, protocol code, credential-generation code, or behavior-signature code is in an acceptable state.

Existing approaches may separately use device certificates, secure boot, PUF keys, or remote attestation. However, separation of these mechanisms can leave a gap between device authenticity, code integrity, behavior-time evidence, and the credential presented to a remote verifier.

Accordingly, there is a need for a technical architecture that binds hardware-rooted identity, measured code integrity, behavior-time evidence, domain or verifier context, credential generation, freshness protection, and remote attestation into a common evidence flow.

### SUMMARY

In one embodiment, a secure device includes a hardware trust engine comprising a hardware-unique signal source, an isolated execution environment, a measured integrity gate, a key management module, a behavior signature engine, a credential generation module, and an attestation interface. The hardware trust engine generates or recovers a stable hardware-unique identity value and derives or releases a hardware-rooted cryptographic key only when a measured integrity condition is satisfied.

In one embodiment, the measured integrity condition includes measurement of firmware, boot state, operating system loader, TEE runtime, protocol code, behavior-signature code, credential-generation code, policy code, or other executable state relevant to generation of a behavioral credential.

In one embodiment, a behavior signature engine generates a behavior-time proof associated with a requested operation. The proof may comprise a signed behavior event, selective-disclosure proof, zero-knowledge proof, proof hash, predicate result, or equivalent proof object indicating that a behavior condition and a time condition have been satisfied.

In one embodiment, a credential generation module produces a domain-associated behavioral credential that cryptographically binds the hardware-rooted cryptographic key, the behavior-time proof, and an integrity measurement associated with the measured integrity condition. Signed attestation evidence including the credential and a freshness value is transmitted to a remote verifier over a secure communication channel.

### BRIEF DESCRIPTION OF THE DRAWINGS

FIG. 1 illustrates an overall hardware trust engine architecture for generating hardware-rooted behavioral credential attestation.

FIG. 2 illustrates a hardware-unique identity recovery flow using a PUF challenge-response or equivalent hardware-unique signal source.

FIG. 3 illustrates measured integrity gating performed within an isolated execution environment before cryptographic key usage.

FIG. 4 illustrates hardware-rooted key derivation and secure storage controlled by measured integrity.

FIG. 5 illustrates behavior-time proof generation associated with a requested operation.

FIG. 6 illustrates a domain-associated behavioral credential object binding hardware-rooted key information, behavior-time proof information, and integrity measurement information.

FIG. 7 illustrates a remote attestation exchange using verifier freshness information and signed evidence.

FIG. 8 illustrates secure channel transmission of signed attestation evidence to a remote verifier.

FIG. 9 illustrates a chain of behavioral credentials linked by cryptographic references.

FIG. 10 illustrates revocation and tamper response when measured integrity or hardware identity checks fail.

FIG. 11 illustrates field provisioning, re-challenge, key rotation, and credential renewal while maintaining hardware-root dependence.

FIG. 12 illustrates chip-level hardware security architecture improvement without requiring semiconductor fabrication changes.

FIG. 13 illustrates verifier-side validation of a behavioral credential and attestation evidence.

FIG. 14 illustrates a failure path in which key release and credential issuance are blocked.

FIG. 15 illustrates an optional interface with an external verification or audit service without making such external service the hardware root.

FIG. 16 illustrates a comparison between static device identity and hardware-behavior trust evidence.

### DETAILED DESCRIPTION

### System Overview

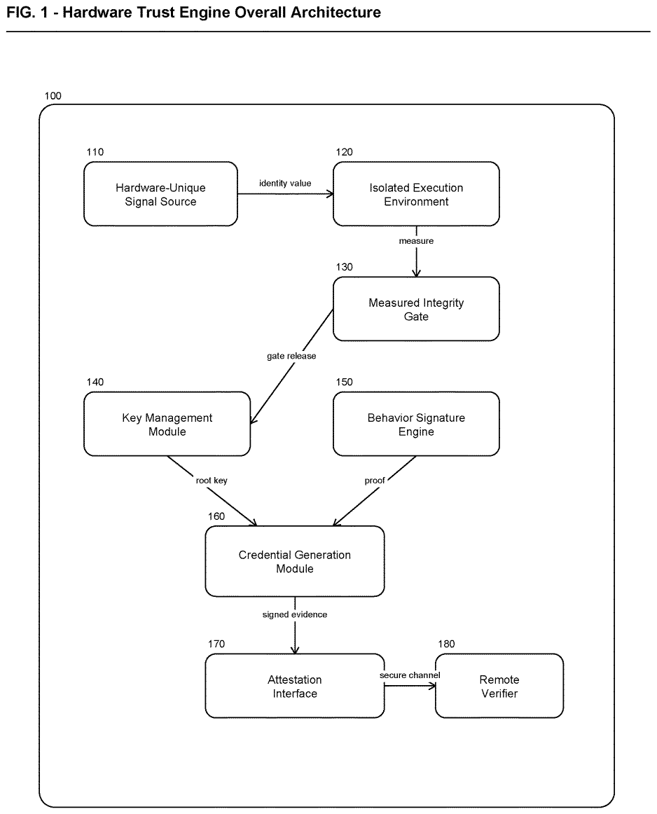

FIG. 1 shows a secure device including a hardware-unique signal source, an isolated execution environment, a measured integrity gate, a key management module, a behavior signature engine, a credential generation module, an attestation interface, and a remote verifier. The arrangement is representative and components may be integrated into a chip, secure element, trusted execution module, device processor, or hardware trust module.

The hardware-unique signal source may be a PUF module, an array of physically distinct silicon elements, a secure element identity source, or another device-unique hardware signal source. The signal source supports generation or recovery of a stable hardware-unique identity value that is not merely a software password or a conventional stored token.

The isolated execution environment may be a TEE, secure enclave, secure element, trusted module, isolated secure processor, or equivalent hardware-protected execution environment. The isolated execution environment protects measurement, key derivation, key release, behavior proof processing, credential generation, and signing from ordinary application memory.

The measured integrity gate measures firmware, protocol code, boot state, execution state, or credential-generation code. A hardware-rooted cryptographic key may be derived or released only when the measured integrity condition is satisfied. This creates a technical dependency between acceptable code state and credential issuance.

### Hardware-Unique Identity Recovery

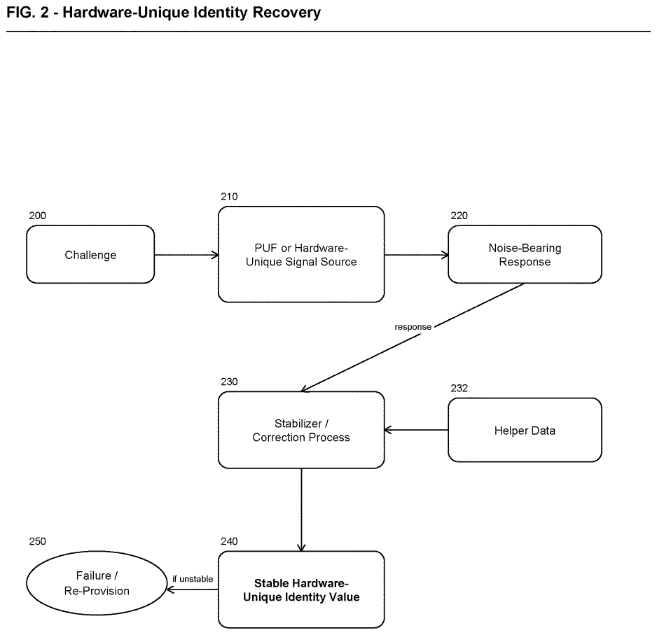

FIG. 2 shows a hardware-unique identity recovery flow. A challenge is applied to a hardware-unique signal source. The source produces a response that is characteristic of the physical device. A stabilizing or correction process may produce a stable hardware-unique identity value suitable for cryptographic use.

In a representative embodiment, the hardware-unique signal source is a PUF module that generates a device-specific challenge-response value. The PUF response may originate from physical manufacturing variation, delay variation, start-up state variation, analog variation, or another physical characteristic that is difficult to clone in a second device.

The stable hardware-unique identity value does not need to be stored as a permanent plaintext key. Instead, the physical device can reproduce or recover the value under controlled conditions. This reduces reliance on a static secret stored in ordinary memory and supports device-specific root-key derivation.

If the hardware response cannot be stabilized or deviates beyond an acceptable correction range, the isolated execution environment may block key derivation, set a failure state, refuse credential issuance, require field provisioning, or notify a verifier service that hardware identity cannot be confirmed.

### Measured Integrity Gating

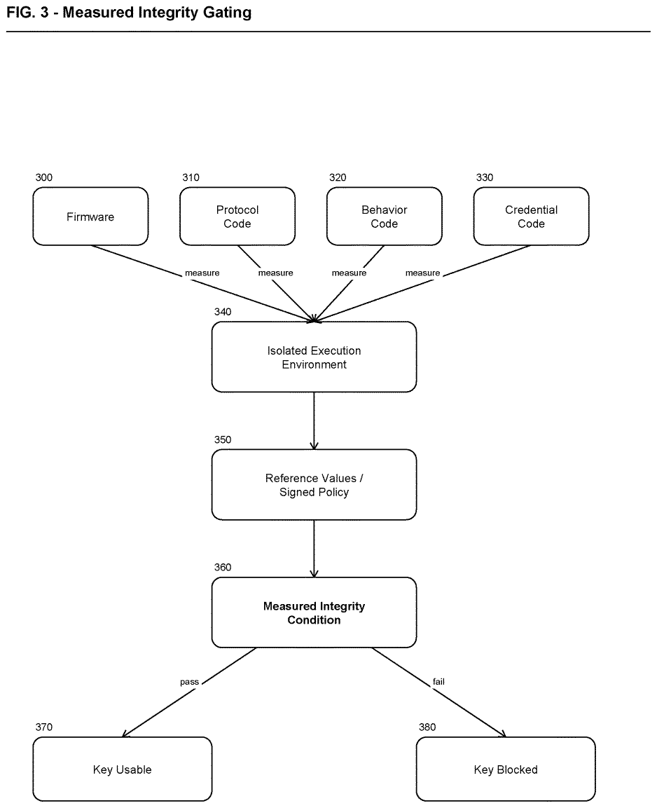

FIG. 3 shows measured integrity gating. Firmware, protocol code, behavior-signature code, and credential-generation code may be measured inside or under control of an isolated execution environment. The measured values are compared against reference values or against a signed policy.

The measured integrity condition may be satisfied when the measured firmware, boot state, protocol code, execution state, or policy module corresponds to an expected baseline. If the measured values do not match the baseline, the hardware-rooted cryptographic key is not released or is not made usable for credential generation.

This gating relationship is central to the technical improvement. A device is not trusted merely because it possesses a device identity. The device must also show that its relevant execution state is acceptable before using the hardware-rooted key to sign or bind behavioral evidence.

Measured integrity gating may occur during boot, during credential generation, during remote attestation, during field provisioning, after an update, after a policy change, or in response to a verifier challenge.

### Key Derivation, Release, and Storage

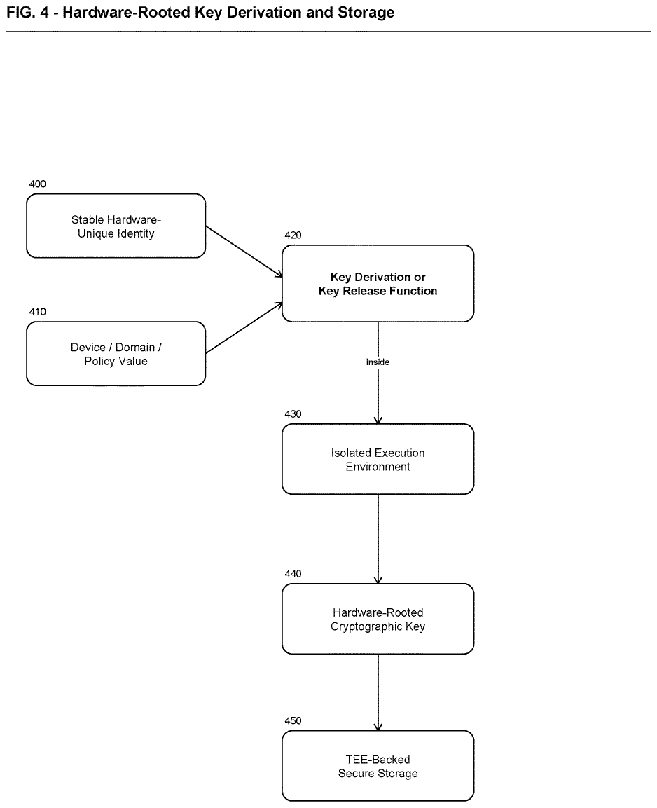

FIG. 4 shows hardware-rooted key derivation and secure storage. A stable hardware-unique identity value and an optional device, domain, policy, or challenge value are provided to a key derivation or key release function operating within or under control of the isolated execution environment.

The key management module may apply a key derivation function to the stable hardware-unique identity value. The derivation may further incorporate a device-specific value, verifier challenge, domain value, policy value, salt, or credential scope.

The hardware-rooted cryptographic key may remain non-exportable. Ordinary application code may request a signature, wrapped session key, credential, attestation report, or secure-channel operation, but may not read the raw root key.

Key release may be conditional on measured integrity. If the measured integrity condition is not satisfied, the key is not derived, not unsealed, not made usable, or not permitted to sign a credential.

### Behavior-Time Proof Generation

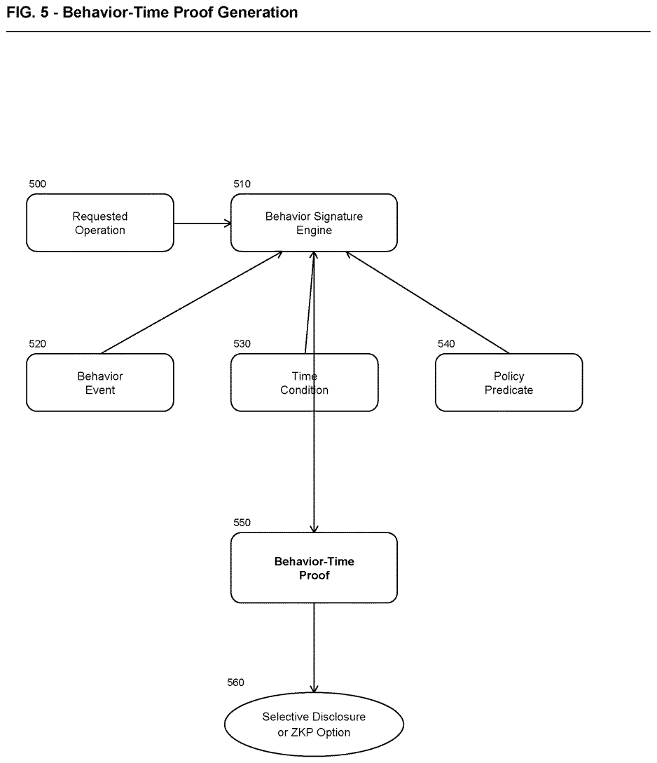

FIG. 5 shows behavior-time proof generation. A requested operation provides context to a behavior signature engine. The behavior signature engine receives or observes a behavior event, a time condition, and an optional policy predicate. The engine outputs a behavior-time proof.

A behavior-time event may include a user confirmation, terminal interaction, sensor-derived signal, device-state condition, proximity signal, time-of-event record, policy satisfaction result, or other evidence associated with a requested operation.

The behavior-time proof may be a signed behavior event, selective-disclosure proof, zero-knowledge proof, proof hash, predicate result, or equivalent proof object. The proof indicates that a behavior condition and a time condition have been satisfied according to a policy.

Privacy may be preserved by disclosing a proof or predicate result rather than the complete behavior record. For example, a verifier may need to know that a behavior event occurred within an authorized window and at an enrolled terminal without receiving all underlying sensor data.

### Credential Binding Structure

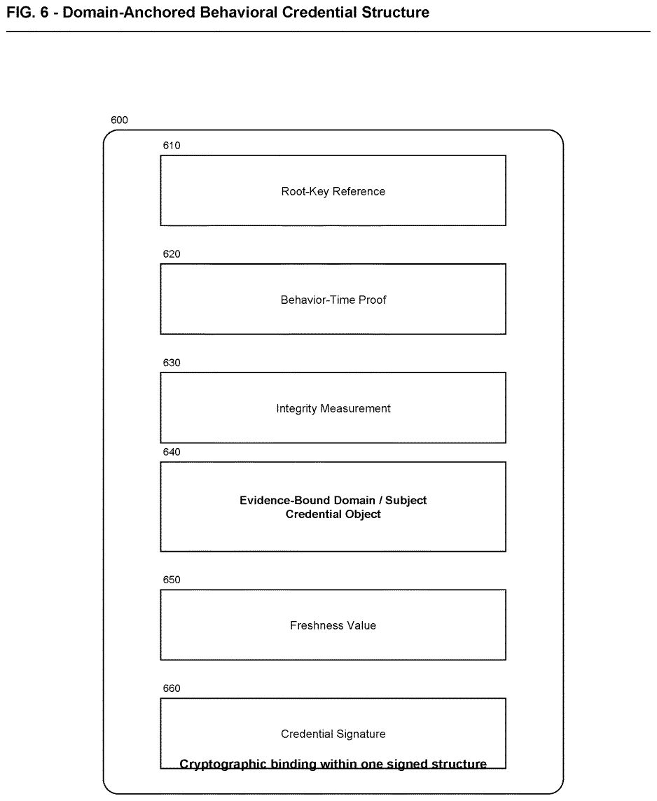

FIG. 6 shows a behavioral credential object. The credential may include a root-key reference, a behavior-time proof reference, an integrity measurement reference, an evidence-bound domain or subject reference, a freshness value, and a credential signature. The specific field names are examples.

The credential generation module cryptographically binds the hardware-rooted key, the behavior-time proof, and the measured integrity information into a single structure. Binding may occur by signing the fields together, hashing them into a credential body, including references to them in a signed certificate, or packaging them in a token accepted by a remote verifier.

A domain-associated credential is linked to a domain, service endpoint, terminal endpoint, verifier context, domain-root trust anchor, or domain-linked service portal. The term indicates that the credential is associated with a defined verification context or service scope, and does not require ownership of a public Internet domain name.

The credential is stronger than a static device identifier because it can show not only that a device identity exists, but also that the credential was generated under acceptable measured code state and was bound to behavior-time evidence relevant to the requested operation.

### Remote Attestation and Secure Communication

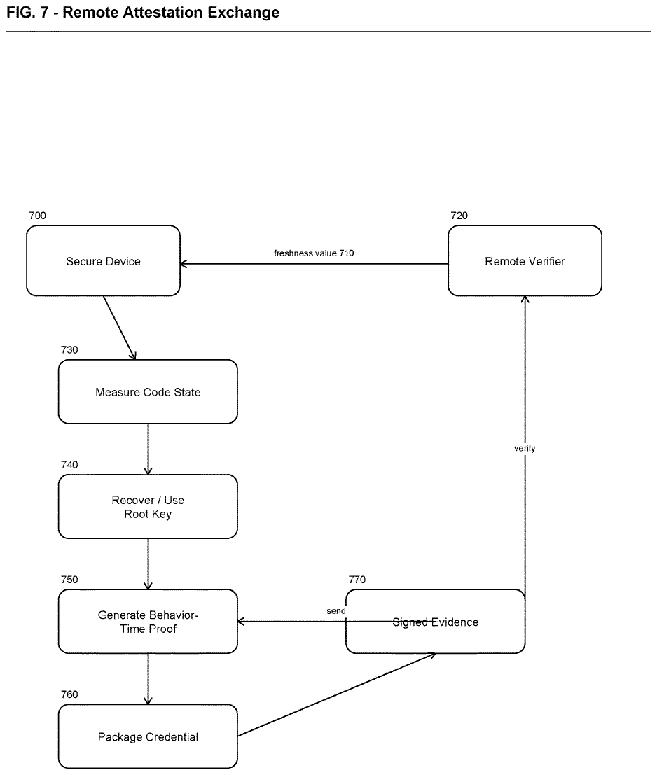

FIG. 7 shows a remote attestation exchange. A secure device receives a verifier freshness value from a remote verifier, measures relevant code state, generates or recovers the hardware-rooted key, generates a behavior-time proof, packages a behavioral credential, signs attestation evidence, and transmits the signed evidence to the remote verifier.

The freshness value may be a verifier challenge, nonce, timestamp, short-lived session value, counter value, or equivalent anti-replay value. Inclusion of the freshness value can prevent reuse of old evidence in a new transaction.

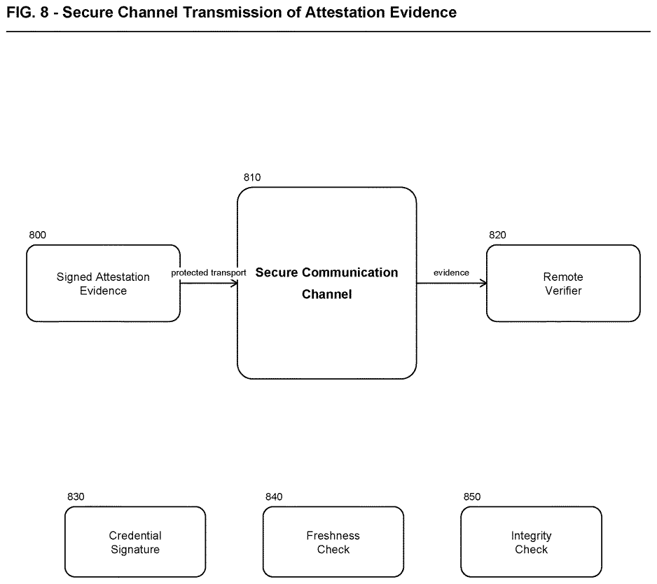

FIG. 8 shows secure channel transmission. Signed attestation evidence is transmitted through a secure communication channel to a remote verifier. The secure channel may provide confidentiality, integrity, mutual authentication, or transport protection.

The verifier may check a credential signature, attestation signature, measured integrity baseline, domain reference, behavior-time proof, freshness value, expiration value, and revocation pointer.

### Credential Chains and Continuity

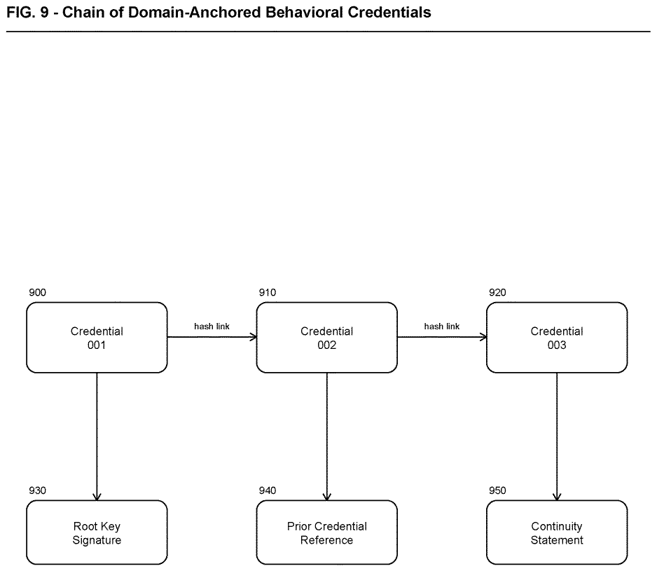

FIG. 9 shows a chain of behavioral credentials. A first credential may be followed by a second credential and a third credential. Each credential may include a reference to a prior credential, a hash of a prior credential, a sequence value, a key rotation reference, or a renewal statement.

Credential chaining can preserve continuity across credential renewal, key rotation, field provisioning, software update, or domain policy update. The chain may allow a verifier to distinguish legitimate maintenance from an unexpected new device or unauthorized credential issuance.

A chain does not require every credential to reveal all prior behavior records. A credential may include only a previous credential identifier, a hash commitment, or a continuity proof. This preserves privacy while maintaining technical linkage.

Credential continuity is useful in terminals, financial systems, medical systems, and public-service systems where a device may receive updates or periodic re-provisioning but must remain tied to a hardware-rooted identity and code-integrity-gated credential-generation process.

### Revocation, Failure, and Field Provisioning

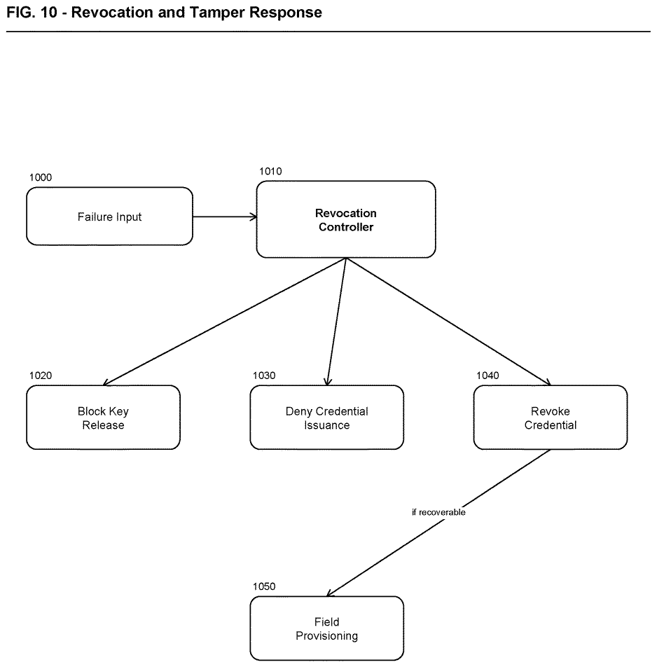

FIG. 10 shows revocation and tamper response. A failure input, such as PUF instability, failed measured boot, behavior-proof inconsistency, expired policy, or failed attestation, is evaluated by a revocation controller. The controller may block key release, deny credential issuance, revoke a credential, or require field provisioning.

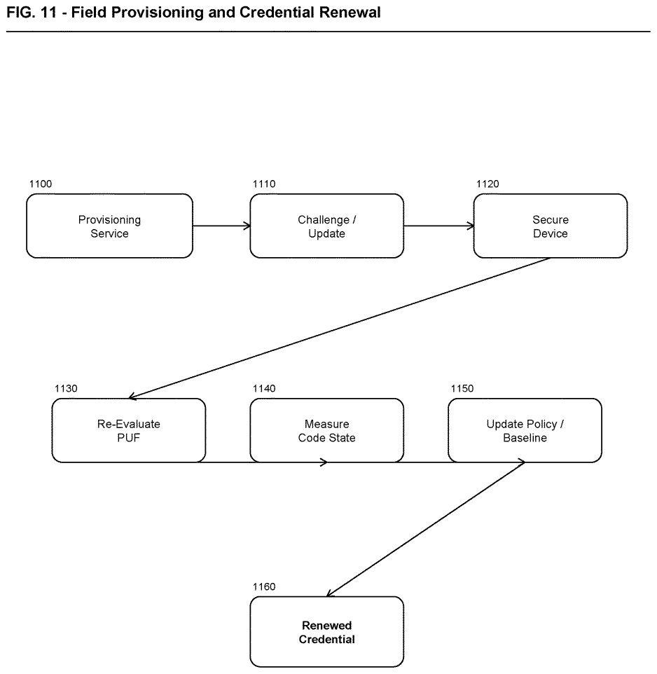

FIG. 11 shows field provisioning. A provisioning service provides a challenge or update to the secure device. The device re-evaluates the hardware-unique signal source, measures code state, updates expected values or policy, and issues a renewed credential only when the hardware root and measured integrity remain acceptable.

Revocation may be triggered by hardware response instability beyond an allowed correction range, failed measured integrity, failed verifier challenge, credential expiration, compromised credential-generation code, policy withdrawal, or inconsistency in a behavior-time proof.

Failure handling may be granular. The system may deny high-risk credential issuance while permitting a diagnostic report, may allow only temporary read-only access, may require a new verifier challenge, or may route the device to a provisioning workflow.

### Chip-Level Trust Functionality

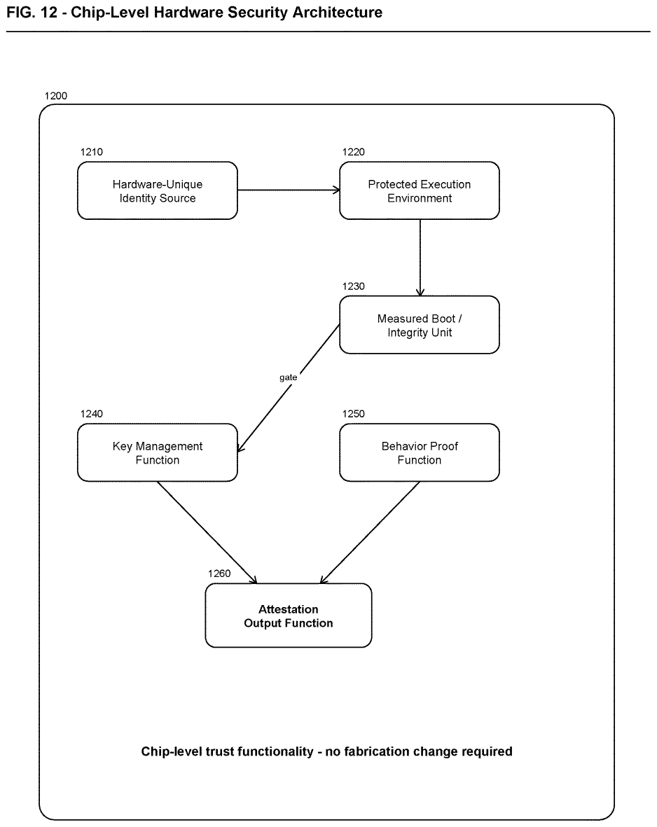

FIG. 12 shows chip-level trust functionality. A chip or device processor may include a hardware-unique identity source, a protected execution environment, a measured boot or integrity unit, a key management function, a behavior proof function, and an attestation output function. The figure describes a security architecture, not a semiconductor fabrication method.

The disclosed technology can be implemented in a secure element, trusted execution module, secure enclave, device processor, terminal security module, or hardware trust module. The improvement concerns how the device derives, gates, binds, signs, and attests a credential under hardware and code-integrity control.

The invention does not require changing wafer fabrication, photolithography, packaging, transistor layout, or semiconductor manufacturing process steps. A manufacturer or device integrator can implement the trust functionality as an intellectual-property block, firmware-controlled secure element, secure enclave function, trusted module, or integrated hardware security architecture.

Because the credential depends on both a hardware-rooted key and measured integrity, the chip-level trust function is more than a device serial number. It functions as a trust engine that can produce behavior-bound, code-state-bound evidence for a remote verifier.

### Verifier-Side Validation

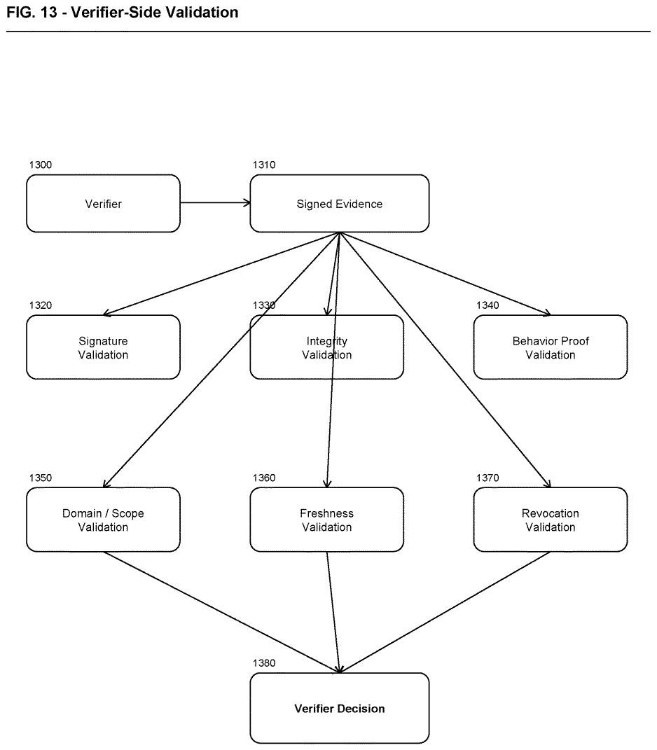

FIG. 13 shows verifier-side validation. A verifier receives signed attestation evidence and validates signature state, measured integrity state, behavior-time proof state, domain or service scope, freshness state, and revocation state before issuing a decision.

The verifier may be a server, terminal, gateway, domain service, medical system, financial system, enterprise service, government service portal, industrial controller, or other remote verifier. The verifier need not know the raw PUF response or raw behavior data if it can validate the signed credential, proof, and measurement references.

A verifier may decide to permit, deny, limit, delay, or request additional proof. For a low-risk operation, a valid credential with recent integrity measurement and current freshness value may be sufficient.

Verifier-side validation can reduce replay and credential theft because an attacker who copies an old credential without the current freshness value and current measured state may fail verification.

### Failure Path and Key Blocking

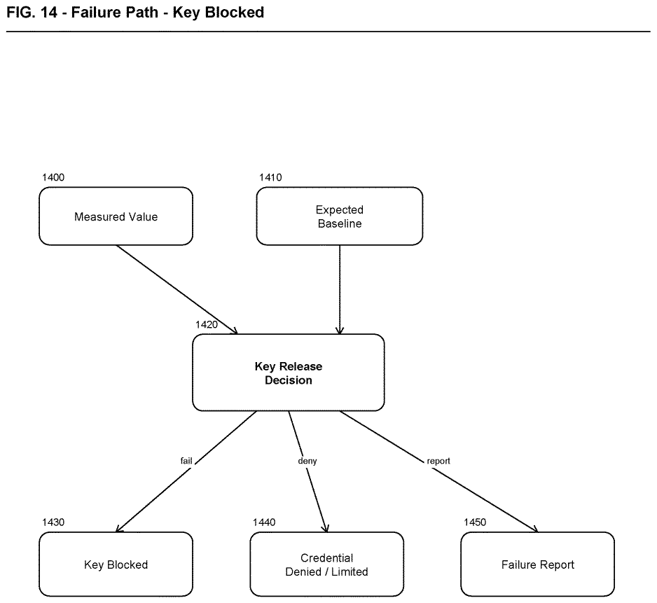

FIG. 14 shows a failure path. If a measured value does not satisfy an expected baseline, a key release decision blocks use of the hardware-rooted key. Credential issuance is denied or limited, and a failure report may be produced.

If a behavior-time proof fails, the key may remain protected even though device integrity is acceptable. If device integrity fails, the behavior-time proof may not be bound into a credential. In this way, the evidence flow requires both acceptable device state and acceptable behavior-time proof before producing a full credential.

A failure report may include a non-sensitive failure code, measurement class, policy identifier, time, device reference, or verifier challenge reference. The failure report need not reveal raw PUF data or raw behavior data.

Blocking key use at the measured integrity gate prevents ordinary application code from using a valid device key after code compromise. This is a technical improvement over systems that issue credentials whenever a stored key is accessible.

### Optional External Verification Interface

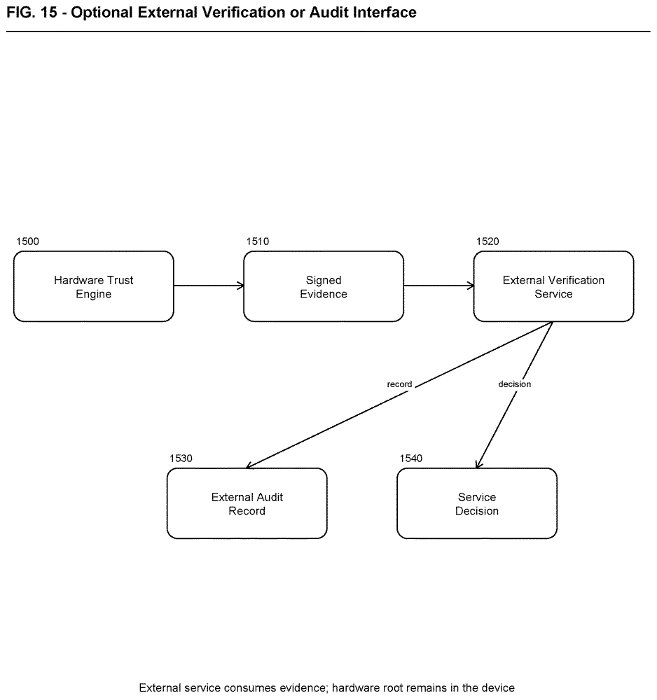

FIG. 15 shows an optional interface with an external verification or audit service. The hardware trust engine outputs signed evidence to an external verification service. The service may generate an audit record and a service decision. This external service is optional and does not replace the hardware root, measured integrity gate, behavior-time proof, credential binding, or remote attestation components.

The external service may be a verifier, registry, audit log, credential service, policy service, terminal management service, or institutional service. The purpose of the external interface is to consume evidence generated by the hardware trust engine, not to create the hardware-rooted identity by itself.

Using neutral terms for the external service avoids confusing the present hardware trust root with broader graph or ledger systems. The present invention remains directed to the hardware-rooted credential and attestation pipeline.

An external audit record may include credential hash, attestation time, verifier challenge reference, decision result, policy identifier, and revocation pointer. The audit record may support accountability without storing the raw PUF response or unnecessary raw behavior data.

### Static Device Identity Compared With Hardware-Behavior Trust

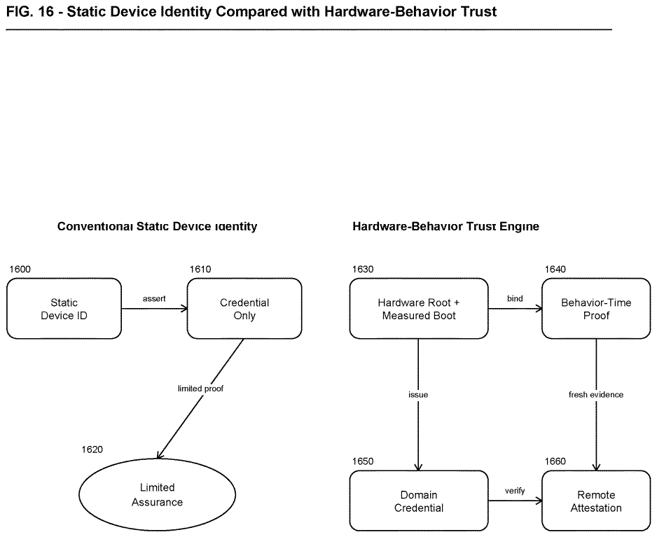

FIG. 16 compares a conventional static device identity process with a hardware-behavior trust engine. A static device identifier may support a credential-only assertion that provides limited assurance. In contrast, a hardware-behavior trust engine uses a hardware root and measured boot, binds it with a behavior-time proof, issues a domain credential, and supports remote attestation.

A static device credential may prove that a device once held a certificate. It may not prove that the device currently runs acceptable code or that a requested behavior-time event occurred under an acceptable policy.

The disclosed trust engine combines physical device uniqueness, measured execution state, behavior-time evidence, credential binding, and verifier freshness. As a result, the remote verifier receives a more complete technical basis for trusting a requested operation.

Changing terminology does not avoid the technical relationship. A system may call the credential a token, certificate, attestation object, evidence object, behavioral proof, or device proof. If the system performs the claimed combination of hardware-rooted key derivation or release, measured integrity gating, behavior-time proof binding, and remote attestation, it uses the same technical pipeline.

### Enrollment Sequence

During enrollment, a provisioning authority or verifier can challenge the hardware-unique signal source, receive attestation evidence from the isolated execution environment, and create a binding between the device and an authorized domain or service context. Enrollment may require a clean measured integrity state before any credential authority is established.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Provisioning Challenge Handling

A provisioning challenge may be generated locally, remotely, or through a terminal. The challenge can prevent a copied response or stale credential from being enrolled as a new hardware root. The challenge may be included in the credential or attestation record to show that enrollment was performed in a fresh session.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Firmware Update Handling

When firmware or protocol code is updated, the measured integrity baseline may change. The system can require a signed update policy before accepting the new baseline. The root key remains tied to the hardware identity, but its use is conditioned on the updated measurement satisfying the signed policy.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Credential Scope Management

A credential may be scoped by domain, terminal, requested operation, amount class, data class, user confirmation state, time window, or verifier type. Scope management reduces risk because a credential generated for one context cannot automatically be reused for another context without satisfying the relevant policy.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Revocation Pointer Usage

A revocation pointer may identify a revocation list, status endpoint, policy object, signed revocation record, or local revocation state. The pointer allows a verifier to determine whether a credential remains active without requiring disclosure of unrelated credential history.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Behavior Proof Input Validation

The behavior signature engine may accept behavior inputs only from trusted sensors, protected terminal input paths, signed application components, or verifier challenge responses. If the input source is not trusted, the engine may produce only a limited proof or may refuse proof generation.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Secure Channel Formation

A secure channel may be established using an attested key, credential-derived session key, verifier challenge, or ordinary mutually authenticated transport. The secure channel protects message delivery, while the signed evidence object preserves independent verifiability.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Verifier Freshness Policy

Freshness policy may specify how long a nonce, timestamp, session value, or counter remains valid. High-risk operations may require a new verifier-supplied challenge, while lower-risk operations may accept a credential generated within a shorter validity window.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Privacy of Hardware Identity

The device may avoid exposing a raw hardware fingerprint by presenting a pseudonymous device commitment, certificate, or derived public key. The verifier can check that evidence is rooted in the expected hardware without receiving the raw PUF response.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Multiple Domain Contexts

A single hardware root may support credentials for multiple domains by deriving domain-specific working keys or including a domain identifier in each credential. This prevents a credential issued for one domain from being replayed as if it were valid for a different domain.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Terminal Implementation

A terminal implementation may include a secure device reader, trusted keypad, secure display, local TEE, secure element, or gateway verifier. The terminal can request hardware evidence from the device and can forward signed attestation evidence to a remote verifier.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Financial Terminal Example

In a financial terminal, the trust engine may be used to verify that a transaction approval credential was generated by an authentic device running acceptable protocol code and bound to a behavior-time event associated with the requested operation.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Medical Terminal Example

In a medical terminal, the trust engine may verify that an emergency access credential is produced by an authorized hardware root and limited to permitted fields or actions. The proof can confirm that a behavior-time condition was satisfied without exposing unrelated data.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Public-Service Terminal Example

In a public-service terminal, the trust engine may support identity or eligibility verification using hardware-rooted evidence, measured integrity, and credential scope. The terminal can transmit evidence to a remote verifier when connectivity is available.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Industrial Device Example

In an industrial device, the trust engine may prove that a control command or maintenance request is associated with a trusted device and acceptable firmware state. If protocol code has changed unexpectedly, the key gate can prevent issuance of a control credential.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Mobile Device Example

In a mobile device, the trust engine may operate inside or beside a secure enclave or trusted execution module. Application software may request credential generation, but the hardware-rooted key remains protected and cannot be directly exported.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Browser Companion Example

A browser hardware companion or local device module may generate a domain-associated credential for a web service. The credential can include a domain reference, behavior-time proof, and measured integrity reference, thereby improving upon password-only or token-only login.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Server-Side Verifier Example

A server-side verifier may maintain policies for accepted measurements, credential scopes, freshness windows, and revocation status. It may reject credentials from an authentic device if the measured code state or behavior-time proof does not satisfy policy.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Audit Receipt Example

After verification, a verifier may generate an audit receipt including the credential hash, decision, policy version, and attestation time. The audit receipt can be used for later review without revealing the raw behavior event or raw hardware identity.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Anti-Replay Operation

Replay protection may combine verifier freshness, expiration values, credential sequence values, and secure-channel context. A copied credential lacking the current freshness value or acceptable time window may be rejected even if its signature was once valid.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Cloning Resistance

A clone without the physical hardware-unique signal source cannot reproduce the stable identity value needed to derive or release the hardware-rooted key. A clone with copied software cannot satisfy the hardware-root dependence and measured integrity gate at the same time.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Malware Resistance

Malware in ordinary application space may request an operation, but it cannot directly obtain the root key. If malware modifies protocol code or credential-generation code that is measured by the TEE, the measured integrity condition can fail and block key use.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Protocol Code Measurement

Protocol code measurement may include hashing executable instructions, configuration values, policy files, credential schemas, or behavior-proof routines. The reference baseline may be provisioned during enrollment or updated by a signed policy.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Policy Controlled Release

Key release may depend on both a measured code state and a policy state. For example, the same device may generate a low-risk credential under one policy while high-risk credential generation requires a different baseline or recent verifier challenge.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Credential Format Flexibility

The credential may be formatted as a certificate, token, structured object, signed binary message, or verifier-specific evidence object. The format is not limiting when the object carries the bound hardware-root, behavior-proof, integrity-measurement, freshness, and signature components.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Non-Exportable Key Behavior

The hardware-rooted key may be non-exportable and may operate through signing or key-wrapping APIs exposed by the isolated execution environment. This allows external systems to verify evidence without requiring disclosure of the protected root key.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Key Rotation With Continuity

Key rotation may produce a new working key while preserving a signed link to the previous credential or root. The link can be represented by a credential hash, renewal record, or continuity statement generated inside the isolated execution environment.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Credential Renewal Policy

Credential renewal may be permitted only if the hardware-unique identity remains stable, measured integrity is acceptable, and the requested scope is authorized. Renewal can be denied or limited if the device state has changed unexpectedly.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Limited Disclosure Verification

The verifier may receive a proof that a behavior predicate is satisfied without receiving the raw behavior data. This feature allows sensitive environments to verify policy compliance while reducing data exposure.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Domain Identifier Use

A domain identifier or service identifier may be included in the credential so that a credential produced for one domain cannot be silently repurposed for another domain. This domain binding is part of the credential evidence.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Verifier Challenge Use

A verifier challenge can be embedded into the evidence before signing. The challenge proves that the evidence was prepared for a current session and not simply copied from a prior transaction.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Local Denial Handling

The device may locally deny credential generation before contacting a remote verifier if the measured integrity condition fails, the behavior-time proof is not available, or the requested scope is outside policy.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Remote Denial Handling

A remote verifier may deny the operation even if the device produced signed evidence when verifier policy, revocation state, freshness state, or credential scope is not satisfied. This layered denial model improves security.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Diagnostics

When a failure occurs, diagnostic evidence may identify the class of failure without exposing protected secrets. A diagnostic report may indicate measurement mismatch, proof unavailable, expired credential, stale challenge, or revoked scope.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### No Fabrication Change Required

The implementation can be supplied as a hardware security architecture within existing chips or devices. The invention improves trust functionality and credential-generation security without requiring changes to wafer fabrication, lithography, packaging, or transistor manufacturing processes.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Design-Around Resistance

Different terminology such as secure enclave, hardware wallet, trusted module, security processor, or device-attestation coprocessor does not avoid the technical relationship when the system still uses a hardware-rooted key, measured integrity gating, behavior-time proof binding, and remote attestation.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Interoperability

The evidence object may interoperate with existing identity platforms, secure terminals, credential systems, and verification servers. Interoperability does not change the hardware-rooted core of the invention.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Evidence Unit Evaluation

A verifier policy may require that the same signed evidence object carry a hardware-root reference, a measured-code reference, a behavior-proof reference, and a freshness reference so that the verifier can evaluate the evidence as a single unit rather than as unrelated assertions.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Modular Device Implementation

A device implementation may separate the hardware-unique identity source from the behavior signature engine while keeping both under an attestation policy enforced by the isolated execution environment. This separation can support modular design without removing the measured integrity gate.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### High-Risk Operation Freshness

A terminal implementation may request a fresh attestation before a high-risk operation and may accept a shorter credential validity window for such operation. The shorter window reduces replay risk while preserving the same hardware-rooted credential structure.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Limited Failure Report

A credential issuance policy may specify that failure of measured integrity prevents signing of a full credential while still allowing the device to provide a limited failure report. The failure report may be signed without exposing the protected root key.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Proof Representation

The behavior-time proof may be represented by a proof object, hash commitment, signed predicate result, or selective-disclosure field. The selection of proof representation does not change the cryptographic binding between the proof, the hardware-rooted key, and the measured integrity reference.

In this implementation, the operation remains tied to the parent-supported core of a hardware-unique signal source, isolated execution environment, measured integrity gating, hardware-rooted cryptographic key, behavior-time proof, credential binding, signed evidence, and remote verifier.

The implementation can be divided between a chip, secure element, trusted execution module, device processor, terminal, gateway, or verifier, provided that the hardware-rooted credential generation and remote attestation relationship is maintained.

### Claim Support and Technical Correspondence

Claim 1 is supported by the disclosure of a hardware-unique signal source, measured integrity condition, key derivation or key release, behavior-time proof, credential binding, signed evidence, and remote verifier freshness. The described components cooperate as a single evidence pipeline rather than as separate authentication checks.

Claim 2 is supported by the PUF challenge-response and equivalent hardware-unique signal source disclosure. A PUF circuit may produce a response characteristic of the physical device and can support recovery of a stable hardware-unique identity value.

Claim 3 is supported by the disclosure of stabilization or correction data used with a noise-bearing hardware response. The correction data does not itself become the protected root key and can be used to reproduce a stable identity value under controlled conditions.

Claim 4 is supported by the disclosure of a TEE, secure enclave, secure element, trusted module, isolated secure processor, or equivalent hardware-protected execution environment. The isolated environment protects measurement and key operations from ordinary application memory.

Claim 5 is supported by the disclosure that firmware, protocol code, behavior-signature code, credential-generation code, policy code, or execution state may be measured before key use.

Claim 6 is supported by the key derivation and key release disclosure. A key derivation function may combine the hardware-unique identity value with a device, domain, policy, salt, challenge, or scope value.

Claim 7 is supported by the behavior-time proof disclosure. The proof may be a signed event, selective-disclosure proof, zero-knowledge proof, proof hash, predicate result, or equivalent proof object.

Claim 8 is supported by the credential object disclosure. A credential may include subject, device, domain or verifier context, integrity measurement, behavior proof, expiration, revocation, freshness, and signature fields.

Claim 9 is supported by the freshness disclosure. A verifier challenge, nonce, timestamp, short-lived session value, counter value, or equivalent anti-replay value can prevent old evidence from being reused.

Claim 10 is supported by revocation and failure handling. Credential issuance may be limited, denied, delayed, or revoked if measured integrity fails, behavior proof is unavailable, or hardware identity cannot be confirmed.

Claim 11 is supported by the secure device architecture including a hardware-unique signal source, isolated execution environment, measured integrity gate, key-management circuitry, credential generation circuitry, behavior proof processing, and attestation interface.

Claim 12 is supported by the disclosure of PUF circuits, secure element identity sources, factory-provisioned device-unique values, analog hardware entropy sources, and equivalent hardware-unique identity sources.

Claim 13 is supported by the disclosure that the isolated execution environment prevents ordinary application memory from reading or exporting the hardware-rooted key.

Claim 14 is supported by the privacy-preserving proof disclosure. A proof can indicate policy satisfaction without disclosing raw behavior data unnecessary for the verifier evaluation.

Claim 15 is supported by the secure channel disclosure. Signed evidence may be transmitted to a server, terminal, gateway, service endpoint, or other remote verifier through an encrypted or mutually authenticated channel.

Claim 16 is supported by the computer-readable medium disclosure causing a device having a hardware trust engine to perform identity recovery, measured integrity validation, key release, proof generation, credential binding, and attestation.

Claim 17 is supported by domain, service, terminal, verifier, or scope identifiers in a credential. Such identifiers prevent evidence prepared for one verification context from being silently reused in another context.

Claim 18 is supported by the disclosure that credential generation may be rejected when measured firmware, protocol code, or credential-generation code differs from an expected baseline or signed policy.

Claim 19 is supported by the verifier-side receipt, audit entry, credential reference, or decision record disclosure. These records can support later review without exposing protected raw data.

Claim 20 is supported by field provisioning, key rotation, credential renewal, and revocation workflows that maintain dependence on the hardware-unique identity value and measured integrity condition.

### Conclusion

The embodiments provide a hardware trust foundation for generating domain-associated behavioral credentials that are rooted in physical device identity, gated by measured code integrity, bound to behavior-time evidence, protected against replay by freshness information, and verifiable through signed attestation evidence.

Specific implementations may vary without departing from the disclosed architecture. Components may be combined, separated, or distributed across a chip, secure element, TEE, secure enclave, terminal, server, or verifier, provided that the hardware-rooted credential generation and remote attestation relationship is maintained.

The disclosure improves device-level and chip-level trust functionality by moving from static identification to current, code-state-bound, behavior-aware attestation for remote verification.

### Additional Parent-Safe Implementation Detail 1

In implementation detail 1, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 1, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 1 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 2

In implementation detail 2, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 2, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 2 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 3

In implementation detail 3, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 3, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 3 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 4

In implementation detail 4, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 4, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 4 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 5

In implementation detail 5, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 5, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 5 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 6

In implementation detail 6, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 6, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 6 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 7

In implementation detail 7, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 7, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 7 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 8

In implementation detail 8, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 8, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 8 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 9

In implementation detail 9, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 9, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 9 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 10

In implementation detail 10, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 10, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 10 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 11

In implementation detail 11, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 11, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 11 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 12

In implementation detail 12, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 12, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 12 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 13

In implementation detail 13, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 13, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 13 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 14

In implementation detail 14, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 14, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 14 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 15

In implementation detail 15, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 15, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 15 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 16

In implementation detail 16, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 16, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 16 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 17

In implementation detail 17, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 17, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 17 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 18

In implementation detail 18, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 18, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 18 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 19

In implementation detail 19, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 19, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 19 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 20

In implementation detail 20, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 20, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 20 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 21

In implementation detail 21, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 21, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 21 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 22

In implementation detail 22, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 22, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 22 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 23

In implementation detail 23, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 23, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 23 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 24

In implementation detail 24, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 24, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 24 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 25

In implementation detail 25, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 25, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 25 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 26

In implementation detail 26, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 26, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 26 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 27

In implementation detail 27, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 27, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 27 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 28

In implementation detail 28, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 28, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 28 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 29

In implementation detail 29, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 29, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 29 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 30

In implementation detail 30, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 30, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 30 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 31

In implementation detail 31, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 31, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 31 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 32

In implementation detail 32, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 32, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 32 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 33

In implementation detail 33, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 33, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 33 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 34

In implementation detail 34, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 34, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 34 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 35

In implementation detail 35, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 35, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 35 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 36

In implementation detail 36, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 36, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 36 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 37

In implementation detail 37, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 37, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 37 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 38

In implementation detail 38, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 38, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 38 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 39

In implementation detail 39, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 39, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 39 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 40

In implementation detail 40, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 40, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 40 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 41

In implementation detail 41, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 41, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 41 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 42

In implementation detail 42, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 42, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 42 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 43

In implementation detail 43, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 43, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 43 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 44

In implementation detail 44, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 44, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 44 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 45

In implementation detail 45, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 45, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 45 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 46

In implementation detail 46, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 46, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 46 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 47

In implementation detail 47, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 47, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 47 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 48

In implementation detail 48, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 48, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 48 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 49

In implementation detail 49, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 49, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 49 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 50

In implementation detail 50, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 50, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 50 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 51

In implementation detail 51, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 51, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 51 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 52

In implementation detail 52, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 52, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 52 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 53

In implementation detail 53, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 53, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 53 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 54

In implementation detail 54, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 54, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 54 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 55

In implementation detail 55, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 55, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 55 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 56

In implementation detail 56, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 56, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 56 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 57

In implementation detail 57, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 57, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 57 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 58

In implementation detail 58, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 58, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 58 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 59

In implementation detail 59, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 59, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 59 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 60

In implementation detail 60, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 60, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 60 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 61

In implementation detail 61, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 61, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 61 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 62

In implementation detail 62, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 62, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 62 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 63

In implementation detail 63, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 63, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 63 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 64

In implementation detail 64, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 64, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 64 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 65

In implementation detail 65, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 65, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 65 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 66

In implementation detail 66, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 66, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 66 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 67

In implementation detail 67, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 67, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 67 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 68

In implementation detail 68, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 68, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 68 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 69

In implementation detail 69, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 69, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 69 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 70

In implementation detail 70, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 70, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 70 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 71

In implementation detail 71, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 71, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 71 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 72

In implementation detail 72, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 72, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 72 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 73

In implementation detail 73, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 73, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 73 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 74

In implementation detail 74, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 74, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 74 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 75

In implementation detail 75, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 75, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 75 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 76

In implementation detail 76, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 76, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 76 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 77

In implementation detail 77, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 77, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 77 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 78

In implementation detail 78, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 78, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 78 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 79

In implementation detail 79, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 79, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 79 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 80

In implementation detail 80, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 80, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 80 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 81

In implementation detail 81, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 81, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 81 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 82

In implementation detail 82, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 82, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 82 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 83

In implementation detail 83, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 83, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 83 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 84

In implementation detail 84, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 84, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 84 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 85

In implementation detail 85, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 85, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 85 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 86

In implementation detail 86, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 86, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 86 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 87

In implementation detail 87, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 87, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 87 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 88

In implementation detail 88, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 88, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 88 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 89

In implementation detail 89, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 89, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 89 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 90

In implementation detail 90, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 90, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 90 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

### Additional Parent-Safe Implementation Detail 91

In implementation detail 91, the hardware trust engine maintains the same core dependency between a hardware-unique identity value, a measured integrity condition, a hardware-rooted key, a behavior-time proof, and a signed evidence object. The implementation variation concerns deployment context, policy granularity, verifier interaction, or credential scope, rather than a new economic network or unrelated trust graph system.

For implementation detail 91, a verifier may evaluate one or more of a signature, measurement reference, proof reference, freshness value, domain or service scope, expiration value, and revocation pointer. The verifier does not need to receive the raw PUF response or complete behavior record when a signed proof or commitment is sufficient for the requested operation.

The technical relationship in implementation detail 91 remains the same: key use is conditioned on measured integrity, and credential validity depends on cryptographic binding among the hardware-rooted key, behavior-time proof, and integrity measurement. This supports a useful range of terminals and devices without changing semiconductor fabrication steps.

What is claimed is:

1. A method, performed by a hardware trust engine of a device, for establishing hardware-rooted behavioral credential attestation, the method comprising:
generating or recovering a stable hardware-unique identity value from a hardware-unique signal source of the device;
validating firmware, protocol code, or execution state within an isolated execution environment;
deriving or releasing a hardware-rooted cryptographic key only when the validating satisfies a measured integrity condition;
generating a behavior-time proof associated with a requested operation;
generating a behavioral credential associated with a domain, service endpoint, verifier context, terminal context, or defined verification scope, the behavioral credential cryptographically binding the hardware-rooted cryptographic key, the behavior-time proof, and an integrity measurement associated with the measured integrity condition; and
producing signed attestation evidence comprising the behavioral credential and a verifier freshness value for transmission to a remote verifier over a secure communication channel.

2. The method of claim 1, wherein the hardware-unique signal source comprises a Physical Unclonable Function (PUF) circuit that produces a device-specific challenge-response value.

3. The method of claim 1, wherein the stable hardware-unique identity value is recovered by stabilizing or correcting a noise-bearing hardware response using helper data or equivalent stabilization data.

4. The method of claim 1, wherein the isolated execution environment comprises a Trusted Execution Environment (TEE), secure enclave, secure element, isolated secure processor, trusted module, or equivalent hardware-protected execution environment.

5. The method of claim 1, wherein the measured integrity condition comprises a measured-boot verification of firmware, boot state, protocol code, behavior-signature code, credential-generation code, or policy code.

6. The method of claim 1, wherein the hardware-rooted cryptographic key is derived by applying a key derivation function to at least the stable hardware-unique identity value and a device, domain, policy, challenge, or scope value.

7. The method of claim 1, wherein the behavior-time proof comprises a signed behavior event, selective-disclosure proof, zero-knowledge proof, proof hash, or predicate result indicating that a behavior condition and a time condition are satisfied.

8. The method of claim 1, wherein the behavioral credential includes at least a subject reference, device reference, service or verifier context reference, integrity-measurement reference, behavior-proof reference, expiration value, revocation pointer, freshness value, and credential signature.

9. The method of claim 1, wherein the verifier freshness value comprises a verifier challenge, nonce, timestamp, short-lived session value, counter value, or equivalent anti-replay value.

10. The method of claim 1, further comprising limiting, denying, delaying, or revoking credential issuance when the measured integrity condition fails or when the behavior-time proof is outside an authorized scope.

11. A hardware trust engine device comprising:
a hardware-unique signal source configured to support generation or recovery of a stable hardware-unique identity value;
an isolated execution environment comprising a protected processor, secure enclave, secure element, trusted execution environment, or equivalent protected execution structure configured to validate firmware, protocol code, or execution state;
a measured integrity gate coupled to the isolated execution environment and configured to determine whether a measured integrity condition is satisfied;
key-management circuitry configured to derive or release a hardware-rooted cryptographic key only when the measured integrity condition is satisfied;
credential-generation circuitry configured to bind the hardware-rooted cryptographic key, a behavior-time proof, and an integrity measurement into a behavioral credential; and
an attestation interface configured to output signed attestation evidence comprising the behavioral credential and a verifier freshness value.

12. The hardware trust engine device of claim 11, wherein the hardware-unique signal source comprises a PUF circuit, secure element identity source, factory-fused value, analog hardware entropy source, or equivalent device-unique hardware identity source.

13. The hardware trust engine device of claim 11, wherein the isolated execution environment prevents ordinary application memory from accessing the hardware-rooted cryptographic key.

14. The hardware trust engine device of claim 11, wherein the credential-generation circuitry receives a privacy-preserving proof that confirms a behavior-time condition without disclosing underlying raw behavior data unnecessary for verifier evaluation.

15. The hardware trust engine device of claim 11, wherein the attestation interface is configured to transmit the signed attestation evidence through a mutually authenticated encrypted channel to a server, terminal, gateway, service endpoint, or other remote verifier.

16. A non-transitory computer-readable medium storing instructions which, when executed in a device having a hardware trust engine, cause the device to:
generate or recover a stable hardware-unique identity value;
validate firmware, protocol code, or execution state within an isolated execution environment;
derive or release a hardware-rooted cryptographic key only when a measured integrity condition is satisfied;
generate a behavior-time proof;
bind the hardware-rooted cryptographic key, the behavior-time proof, and an integrity measurement into a behavioral credential associated with a domain, service endpoint, verifier context, terminal context, or defined verification scope; and
output signed attestation evidence comprising the behavioral credential and a verifier freshness value for verification by a remote verifier.

17. The non-transitory computer-readable medium of claim 16, wherein the instructions cause the device to include a domain identifier, service identifier, terminal identifier, verifier identifier, or scope identifier in the behavioral credential.

18. The non-transitory computer-readable medium of claim 16, wherein the instructions cause the device to reject credential generation if a measured value of firmware or protocol code differs from an expected baseline.

19. The non-transitory computer-readable medium of claim 16, wherein the instructions cause the device to associate the signed attestation evidence with an audit record, verification record, credential receipt, or other verifier-side record.

20. The non-transitory computer-readable medium of claim 16, wherein the instructions cause the device to perform field provisioning, key rotation, credential renewal, or revocation while maintaining dependence on the hardware-unique identity value and measured integrity condition.
